(19) United States
(12) Patent Application Publication
(10) Pub. No.: US 2025/0149715 A1
(43) Pub. Date: May 8, 2025

(54) BATTERY ASSEMBLY

(71) Applicants: HYUNDAI MOTOR COMPANY, Seoul (KR); KIA CORPORATION, Seoul (KR)

(72) Inventors: Kyung Mo Kim, Hwaseong-si (KR); Gun Woo Ko, Seongnam-si (KR)

(73) Assignees: HYUNDAI MOTOR COMPANY, Seoul (KR); KIA CORPORATION, Seoul (KR)

(21) Appl. No.: 18/655,960

(22) Filed: May 6, 2024

(30) Foreign Application Priority Data
Nov. 8, 2023 (KR) 10-2023-0153620

(51) Int. Cl. H01M 50/262; H01M 10/613; H01M 10/625; H01M 10/6556; H01M 10/656; H01M 50/211; H01M 50/636

(52) U.S. Cl. CPC H01M 50/262; H01M 10/613; H01M 10/625; H01M 10/6556; H01M 10/656; H01M 50/211; H01M 50/636; H01M 2220/20

(57) ABSTRACT

A battery assembly includes a battery casing having a bottom surface on which a cooling channel is provided. A plurality of fastening grooves is formed by recessing the bottom surface at a plurality of points thereon. The battery assembly also includes a battery module. A lower surface of the battery module is seated on the bottom surface of the battery casing. A plurality of coupling units is provided on an edge of the lower surface at a plurality of points thereon. The coupling units are positioned to protrude toward the bottom surface in such a manner as to correspond to the plurality of fastening grooves. When the battery module is seated on the battery casing, respective ones of the coupling units are inserted into respective ones of the fastening grooves, thereby being fastened thereto and keeping the lower surface in contact with the cooling channel on the bottom surface.

### CROSS REFERENCE TO RELATED APPLICATION

The present application claims the benefit of and priority to Korean Patent Application No. 10-2023-0153620 filed on Nov. 8, 2023, the entire contents of which are incorporated herein for all purposes by this reference.

### BACKGROUND

### Field of the Disclosure

The present disclosure relates to a battery module. More particularly, the present disclosure relates to a battery casing and a battery module seated in the battery casing.

### Description of the Related Art

Batteries have been broadly used for mobile devices, auxiliary electric-power devices, and the like. In addition, the batteries have attracted attention as primary motive power sources for electric vehicles, hybrid electric vehicles, plug-in hybrid electric vehicles, and the like. These vehicles have been proposed as alternatives to solving various problems, such as air pollution, that are caused by gasoline vehicles or diesel-engine vehicles in the related art.

Several tens of battery cells, or as many as several thousands of battery cells, are typically necessary because a significant amount of electric power is required to drive electric vehicles. Electric vehicle batteries may vary in configuration according to types of electric vehicles. However, typically, the electric vehicle battery is configured with a battery cell, a battery module, and a battery pack.

Typically, when the battery module seated in a battery casing forms the battery pack, there are two methods of coupling the battery module to the battery casing. A first method is to cause flanges, to which a fastening mechanism is coupled, to protrude from the front and rear, respectively, of the battery module and to couple the fastening mechanism to the flanges after the battery module is seated. A second method is to form a seating surface, to which the fastening mechanism is coupled, on each edge portion of the battery module. However, these two methods have disadvantages.

Specifically, the first method has the disadvantage of reducing space for the battery casing because a member is required to be separately present within the battery casing in order to secure the fastening surface, corresponding to the protruding flanges, on the battery module. Because the space of the battery casing is reduced, space for the battery module that is to be seated in the battery casing is also reduced. Thus, the size or quantity of battery cells mounted in the battery module is reduced. The first method thus has the disadvantage of reducing energy density.

In the second method, the fastening surface is secured to each edge of the battery module. Therefore, each edge is bent to secure a fastening seating area of a fastening unit within the battery module. Thus, an excess sealing material of a pouch-type battery cell that is mounted within the battery module is necessarily required to be bent. Because a terrace portion (i.e., the excess sealing material of the pouch-type battery cell) of the battery cell is bent, venting for injecting internal gas may not occur smoothly. Thus, a problem arises in that the stability of a battery is decreased.

### SUMMARY

According to embodiments of the present disclosure, a battery assembly is provided. More particularly, embodiments of the present disclosure provide a coupling structure of a battery casing and a battery module seated in the battery casing. In the related art, the battery casing and the battery module are coupled to each other using a bolt-fastening technique. However, the bolt-fastening technique has the disadvantage of reducing the stability of a battery and the energy density of a battery pack.

Therefore, an object of the present disclosure is to provide a battery assembly from which not only a member structure required to couple a battery casing and the inside of a battery pack to each other is eliminated, but also a fastening seating surface secured on an edge of a battery module is eliminated. The battery assembly can improve the stability of a battery and the energy density of a battery pack.

The technical objects of the present disclosure are not limited to the above-mentioned technical objects. Other technical objects that are not mentioned should be readily understood by those having ordinary skill in the art from the following description.

According to an aspect of the present disclosure, a battery assembly is provided. The battery assembly includes a battery casing having a bottom surface to which a cooling channel is provided. A plurality of fastening grooves is formed by recessing the bottom surface at a plurality of points thereon. The battery assembly further includes a battery module. A lower surface of the battery module is seated on the bottom surface of the battery casing. A plurality of coupling units is provided on an edge of the lower surface of the battery module at a plurality of points thereon. Coupling units, among the plurality of coupling units, are positioned to protrude toward the bottom surface of the battery casing in such a manner as to correspond to the plurality of fastening grooves. When the battery module is seated on the battery casing, respective ones of the coupling units are inserted into respective ones of the fastening grooves, thereby being hooked and fixed thereto and keeping the lower surface of the battery module in close contact with the cooling channel on the bottom surface.

In an embodiment, the cooling channel may be formed by being extrusion-molded in a vertical direction. A flow path, along which a cooling medium flows, may be formed in a straight line along the vertical direction, within the cooling channel.

In an embodiment, a plurality of flow paths may be formed in the cooling channel. A fastening groove, among the plurality of fastening grooves, may be formed in a manner that avoids overlapping with the cooling channel.

In an embodiment, a plurality of flow paths may be formed in the cooling channel. At least some of the plurality of flow paths may be spaced apart from each other. The fastening groove may be formed at a point where the flow paths are separated from each other.

In an embodiment, the coupling units may be welded or chemically bonded to clamps provided on both sides of the battery module. The clamps may press against the battery module.

In an embodiment, an upper end portion of a coupling unit, among the plurality of cooling units, may be caused to extend in a horizontal direction, thereby forming a coupling seating surface. The coupling unit may be welded or chemically bonded to the clamp in a state where the coupling seating surface is brought into surface contact with the clamp.

In an embodiment, an injection hole may be formed in the battery casing in a manner that passes through the bottom surface of the battery casing. A gap filler may be applied through the injection hole after the battery module is seated.

In an embodiment, the fastening groove may be a hole in the battery casing such that the hole passes through the bottom surface thereof.

In the battery assembly, the coupling unit may be formed in such a manner that a length in a height direction thereof is greater than a depth of the fastening groove. A lower end portion of the coupling unit may be exposed to face below the bottom surface of the battery casing in a state where the coupling unit is inserted into the fastening groove.

In an embodiment, a first fixation portion may be formed on the lower end portion of the coupling unit in a manner that protrudes in a vertical direction. The fastening groove may be formed in such a manner that a length in a vertical direction thereof is equal to or greater than a length of the vertical direction of the lower end portion of the coupling unit. In a state of being inserted into the fastening groove, the coupling unit may be slid in such a manner as to prevent a gap from occurring between an upper end of the coupling unit and the fastening groove and then. The lower end portion of the coupling unit may be caused to extend sideways in such a manner as to be brought into surface contact with the battery casing.

In an embodiment, the lower end portion of the coupling unit may be caused to extend sideways in such a manner as to be brought into surface contact with the battery casing. A fixation material may be applied to a vicinity of a surface contact portion, thereby fixing the coupling unit.

In an embodiment, a first binding unit and a second binding unit may be formed in such a manner as to correspond to each other in a state where the lower end portion of the coupling unit is caused to extend sideways in such a manner as to be brought into surface contact with the battery casing. The first binding unit and the second binding unit may be respectively provided in the lower end portion of the coupling unit and the battery casing.

In an embodiment, a second fixation portion may be formed on an end portion of the first fixation portion in a manner that protrudes in the height direction. A coupling groove, into which the second fixation portion is coupled, may be formed in the battery casing, and thus the second fixation portion may be coupled into the coupling groove in a state where the coupling unit is inserted into the fastening groove.

In an embodiment, the coupling unit may be formed in such a manner that a lower end portion thereof is caused to extend in a horizontal direction. One side portion of the fastening groove may be formed to have a greater width in the horizontal direction than the lower end portion of the coupling unit in such a manner that the lower end portion, extending sideways, of the coupling unit passes through the fastening groove. The coupling unit may be inserted into the fastening groove through the one side portion thereof and may be slid to the other side portion having a smaller width in the horizontal direction than the one side portion, thereby being fixed.

In an embodiment, a blocking portion may be formed on the other side portion of the fastening groove in a manner that protrudes in a vertical direction, the coupling unit may be slid to the other side portion of the fastening groove. The coupling unit may be fixed to the fastening groove by the blocking portion.

In an embodiment, respective pack side members may be provided on both sides of the battery casing. The battery module may be coupled in such a manner that a lower edge thereof is directly inserted into a corner portion that is formed by the pack side member and the cooling channel.

According to embodiments of the present disclosure, the battery casing and the battery module are coupled to each other by employing a new-type fastening technique instead of a fastening technique used in the related art. Thus, the stability and the energy density of the battery can be improved when compared with a battery assembly in the related art.

In addition, a member structure that, in the related art, is required to couple the battery casing and the battery module can be eliminated, thereby reducing the weight of the battery assembly. Furthermore, the space in the width of the battery casing, which would be otherwise occupied by the member, can be utilized for loading the battery module.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a view illustrating a battery assembly, according to an embodiment of the present disclosure;

FIG. 2 is a view illustrating a battery module in FIG. 1, according to an embodiment of the present disclosure;

FIG. 3 is a view illustrating a battery casing in FIG. 1, according to an embodiment of the present disclosure;

FIG. 4 is a view illustrating a state where a coupling unit according to a first embodiment of the present disclosure is inserted into a fastening groove;

FIG. 5 is a view illustrating a state where the coupling unit in FIG. 4 is fixed to the battery casing, according to an embodiment of the present disclosure;

FIG. 6 is a view illustrating a state where a second embodiment of the present disclosure is inserted into the fastening groove;

FIG. 7 is a view illustrating a state where the coupling unit in FIG. 6 is fixed to the battery casing, according to an embodiment of the present disclosure;

FIG. 8 is a view illustrating a state where a coupling unit according to a third embodiment of the present disclosure is fixed to the battery casing;

FIG. 9 is a view illustrating a state where a coupling unit according to a fourth embodiment of the present disclosure is fixed to the battery casing; and

FIG. 10 is a cross-sectional view taken along line X-X on FIG. 1, according to an embodiment of the present disclosure.

### DETAILED DESCRIPTION

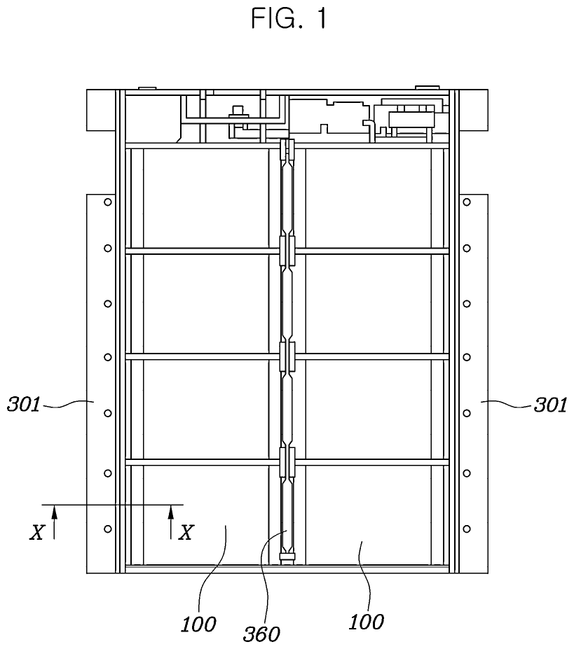

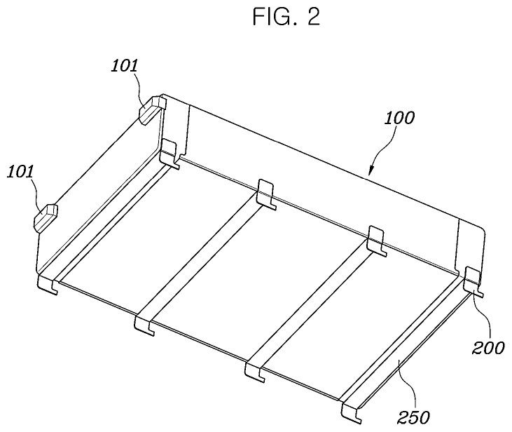

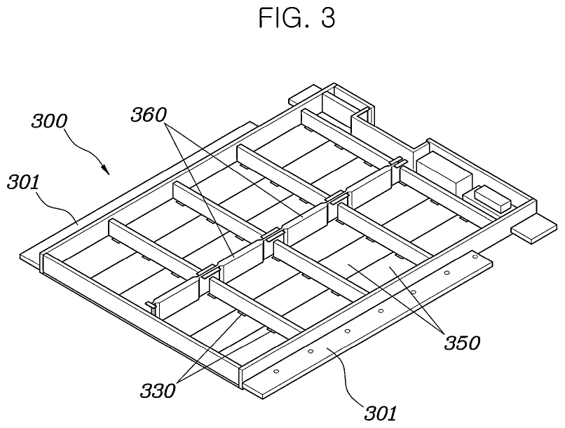

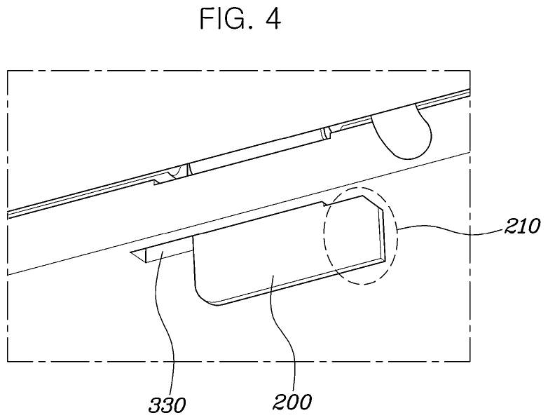

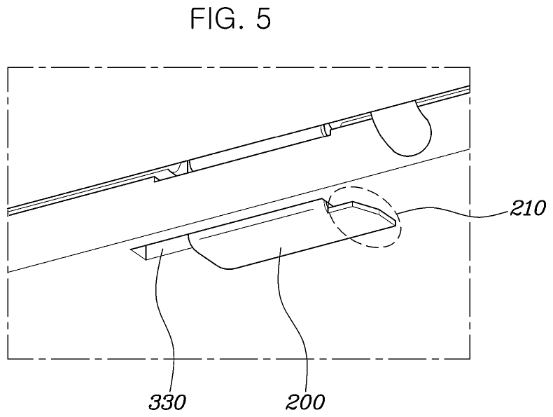

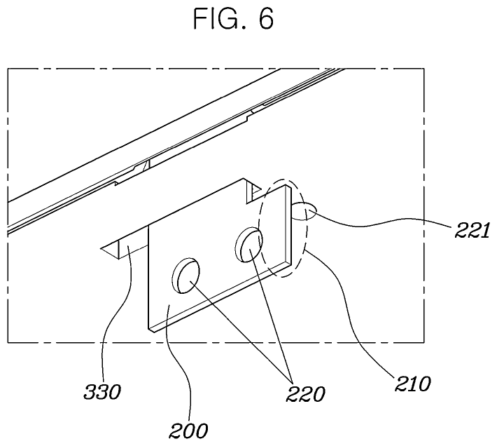

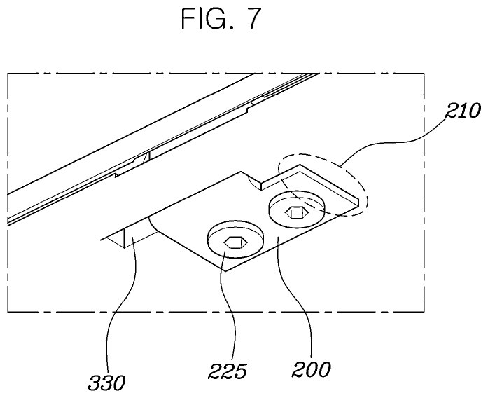

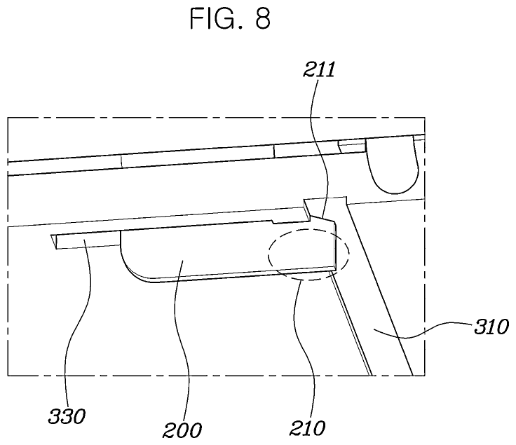

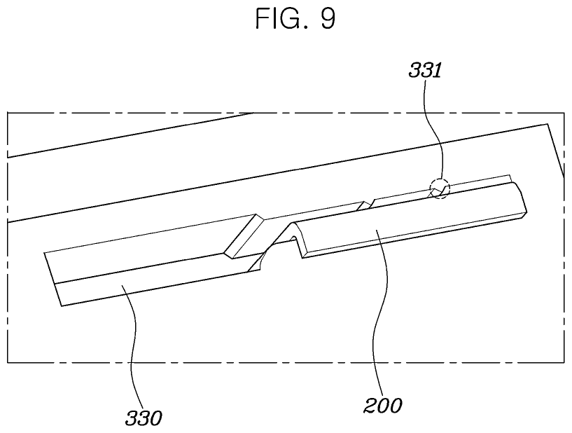

FIG. 1 is a view illustrating a battery assembly, according to an embodiment of the present disclosure. FIG. 2 is a view illustrating a battery module in FIG. 1. FIG. 3 is a view illustrating a battery casing in FIG. 1. FIG. 4 is a view illustrating a state where a coupling unit according to a first embodiment of the present disclosure is inserted into a fastening groove. FIG. 5 is a view illustrating a state where the coupling unit in FIG. 4 is fixed to the battery casing. FIG. 6 is a view illustrating a state where a second embodiment of the present disclosure is inserted into the fastening groove. FIG. 7 is a view illustrating a state where the coupling unit in FIG. 6 is fixed to the battery casing. FIG. 8 is a view illustrating a state where a coupling unit according to a third embodiment of the present disclosure is fixed to the battery casing. FIG. 9 is a view illustrating a state where a coupling unit according to a fourth embodiment of the present disclosure is fixed to the battery casing.

Embodiments of the present disclosure are described in detail below with reference to the accompanying drawings. The same or similar constituent elements are given the same reference numeral, and descriptions thereof are not repeated.

In describing the embodiments of the present disclosure, where it was determined that a detailed description of well-known features or functions may obscure the nature and gist of the present disclosure, a detailed description thereof has been omitted. In addition, the accompanying drawings serve merely to enhance understanding of the embodiment disclosed in the present specification. It should be understood that the technical idea disclosed in the present specification is not limited by the accompanying drawings. Furthermore, it should be understood that any alteration of, any equivalent of, and any substitute for, a constituent element according to the present disclosure, that fall within the scope of the technical idea of the present disclosure, are included within the scope of the present disclosure.

The terms “first,” “second,” and so on are used to describe various constituent elements that have the same function. These terms do not impose any limitation on the meanings of these constituent elements. These terms are used only to distinguish among the constituent elements that have the same function.

A noun in singular form has the same meaning as when used in its plural form unless it has a different meaning in context.

The terms “include,” “have,” “comprise”, and the like in the present disclosure are intended to indicate inclusion of a stated feature, a number, a step, an operation, a constituent element, a component, or a combination of thereof. Such terms should be understood not to preclude the possibility that one or more other features, numbers, steps, operations, constituent elements, components, or combinations of these, are present or added.

With reference to FIGS. 1-3, a battery assembly according to embodiments of the present disclosure may include a battery casing 300 and a battery module 100. The battery casing 300 has a bottom surface on which a cooling channel 350 is provided. A plurality of fastening grooves 330 are formed by recessing the bottom surface at a plurality of points thereon, respectively. A lower surface of the battery module 100 is seated on the bottom surface of the battery casing 300. A plurality of coupling units 200 is provided on an edge of the lower surface of the battery module 100 at a plurality of points thereon, respectively. The coupling units 200 are positioned to protrude toward the bottom surface of the battery casing 300 in such a manner as to correspond to the plurality of fastening grooves 330, respectively. When the battery module 100 is seated on the battery casing 300, the coupling unit 200 is inserted into the fastening groove 330, thereby being hooked and fixed thereto and keeping the lower surface of the battery module 100 in close contact with the cooling channel 350 on the bottom surface.

In the related art, there are typically two methods for fixing a battery module to a battery casing when the battery module is seated in the battery casing, thereby forming a battery pack.

In a first method, flanges are protrusively formed on the front and rear portions, respectively, of the battery module, and a mounting member is separately formed on the battery casing, thereby securing a fastening surface corresponding to the flange. In the first method, the flange on the battery module is seated on the mounting member on the battery casing, and then a fastening mechanism is fastened to the flange and the mounting member. Consequently, the battery module is fixed on the battery casing. In a second method, a fastening unit is formed by securing the fastening surface on each edge portion of the battery module, and the fastening mechanism is fastened to the fastening unit and a bottom surface of the battery casing. However, both the first method and the second method have advantages.

Specifically, in the first method, a mounting member is separately required within the battery casing to secure a fastening seating surface that corresponds to the flange protruding on the battery module. This requirement reduces space in the battery casing. The space in the battery casing is reduced, thereby reducing space for the battery module seated in the battery casing. Therefore, the number and size of battery cells mounted in the battery module are limited. The first method thus has a disadvantage of decreasing the energy density of a battery.

In the second method, the coupling unit is formed by securing the fastening seating surface on each edge of the battery module. Consequently, the terrace portion of the battery cell, that is mounted within the battery module (i.e., the excess sealing material of a pouch-type battery cell) is necessarily caused to extend sideways. Therefore, when gas is vented out of the battery cell, because the terrace portion of the battery cell is caused to extend sideways, the gas within the battery cell may not be smoothly discharged. Consequently, there occurs a problem in that the stability of the battery is decreased.

According to embodiments of the present disclosure, the mounting member required separately within the battery casing in the related art is eliminated, and the terrace portion of the battery cell is not caused to extend sideways. Consequently, the space within the battery casing is efficiently utilized, and the stability of the battery is also achieved.

First, with reference to FIG. 3, the battery casing 300, according to an embodiment, is described. The battery casing 300 has the bottom surface on which the cooling channel 350 is provided. The plurality of fastening grooves 330 are formed by recessing the bottom surface at the plurality of points thereof. Thus, the cooling channel 350 is formed by being extrusion-molded in a vertical direction. A flow path, along which a cooling medium flows, is formed in a straight line along the vertical direction within the cooling channel 350.

First, the cooling channel 350 that is provided on the bottom surface of the battery casing 300, according to an embodiment, is described. The cooling channel 350 is formed by extrusion molding in the vertical direction. The extrusion molding of the cooling channel 350 in the vertical direction enables the cooling channels 350 not only to perform a battery cooling function, but also to serve as a support that enhances the rigidity of the battery casing 300 in the vertical direction.

Therefore, a multiplicity of vertical cross members 360 required within the battery casing 300, as necessary in the related art, is reduced to a minimum. Although the vertical cross member 360 is not provided, the effect of enhancing the rigidity of the battery casing 300 in the vertical direction can be achieved. The number of vertical cross members that are to be provided within the battery casing 300 is minimized. The space within the battery casing 300 can be more efficiently utilized. More battery modules 100 can be mounted in the battery casing 300 than in the related art. The effect of increasing energy density can also be achieved.

In this manner, the cooling channel 350 integrally serves as the support that enhances the rigidity of the battery casing 300 in the vertical direction. Consequently, whenever necessary, the vertical cross member 360 may be provided in an assembled manner on the battery casing 300 according to embodiments of the present disclosure. In other words, the battery module 100 is not seated after the multiplicity of the vertical cross members 360 is formed. Instead, in a case where the rigidity of the battery casing 300 is determined to be required to be enhanced after the battery module 100 is seated in the battery casing 300, the vertical cross member 360 may be provided in an attached manner.

The flow path along which the cooling medium flows may be formed in a straight line within the cooling channel 350. Since the flow path is formed simply in a straight line, the cooling medium circulates quickly. Thus, the battery module 100 seated in the battery casing 300 can be effectively cooled. Even when the fastening groove 330 described below needs to be formed in the bottom surface of the battery casing 300, the fastening groove 330 can be formed in the bottom surface of the battery casing 300 in a manner that easily avoids overlapping with the flow path. Thus, the advantage of easily performing a process of forming the fastening groove 330 can be achieved.

Next, the plurality of fastening grooves 330 that are respectively formed by recessing the bottom surface of the battery casing 300 at the plurality of points thereon, according to an embodiment, are described. The coupling unit 200 on the battery module 100 described below is inserted into the fastening groove 330 and serves to fix the battery module 100.

Unlike in the related art, the fastening groove 330 is formed on the bottom surface of the battery casing 300, and the coupling unit 200 on the battery module 100 described below and the fastening groove 330 are engaged with each other, thereby providing various advantages. For example, the mounting member, that is separately necessary to secure the fastening seating surface in the related art, is no longer necessary within the battery casing 300. Therefore, the mounting member formed within the battery casing 300 is eliminated, thereby achieving the effect of reducing the weight of the battery. In addition, there is no need to separately form the mounting member within the battery casing 300. Consequently, the space that is no longer occupied by the mounting member can be utilized. Thus, the effect of improving the energy density is achieved.

In an embodiment, the fastening groove 330 is formed in a manner that avoids the overlapping with the cooling channel 350. For example, a plurality of flow paths, some of which are spaced apart from each other, are formed in the cooling channel 350. The fastening groove 330 may be formed at a point where the cooling channels 350 are separated from each other.

When the fastening groove 330 is formed in a manner that does not avoid the overlapping with the cooling channel 350, the cooling medium flows to the outside through the fastening groove 330. Thus, the safety of the battery may be compromised. For this reason, the fastening groove 330 should be formed in a manner that avoids the overlapping with the cooling channel 350. In addition, the fastening groove 330 may be formed in the shape of a hole in the battery casing 300 in a manner that passes through the bottom surface thereof. With the fastening groove 330 formed in the battery casing 300 in manner that passes through the bottom surface thereof, the coupling unit 200 described below can serve to fix the battery module 100 in various ways.

Additionally, an injection hole may be formed in the battery casing 300 in a manner that passes through the bottom surface of the battery casing 300, in such a manner that a gap filler is applied through the injection hole after the battery module 100 is seated. After being seated in the battery casing 300, the battery module 100 may be slid into position and fixed in place. When the battery module 100 is slid, a phenomenon where the gap filler is pushed together may occur. Therefore, in an embodiment, in order to avoid this phenomenon where gap filler is pushed, the insertion hole is formed in the battery casing 300 in a manner that passes through the bottom surface thereof. Thus, after the battery module 100 is seated on the bottom surface of the battery casing 300, the gap filler may be injected through the injection hole from the other side of the bottom surface.

The battery module 100, according to an embodiment, is now described with reference to FIG. 2. The battery module 100 is seated on the bottom surface of the battery casing 300. The plurality of coupling units 200 are provided on the edge of the lower surface of the battery module 100 at the plurality of points thereon, respectively. The coupling units 200 are positioned to protrude toward the bottom surface of the battery casing 300 in such a manner as to correspond to the plurality of fastening grooves 330, respectively.

The coupling unit 200 that can serve to fix battery module 100, according to an embodiment, is now described in more detail. The coupling units 200 may be provided by being welded or chemically bonded to clamps 250 provided on both sides of the battery module 100. The clamps 250 press against the battery module 100. The clamps 250, provided on an end plate on each side of the battery module 100, serve not only to apply surface pressure to the battery cell mounted within the battery module 100 by pressing against the battery module 100, but also to fix the battery cell. To this end, the clamps 250 strongly press against both sides of the battery module 100. Thus, with an external force, the camps 250 are not readily separated from the battery module 100. The coupling unit 200 is coupled to the clamp 250. With an external force, a position of the coupling unit 200 is not readily changed. Thus, the coupling unit 200 may be strongly fixed.

An upper end portion of the coupling unit 200 is caused to extend in a horizontal direction, thereby forming a coupling seating surface. The coupling unit 200 may be welded or chemically bonded to the clamp 250 in a state where the coupling seating surface is brought into surface contact with the clamp 250. In a case where the coupling unit 200 is coupled to the clamp 250 with a fastening mechanism such as a bolt, the battery cell provided within the battery module 100 may be damaged. TO prevent this damage, in an embodiment, the coupling unit 200 is welded or chemically bonded to the clamp 250. As used herein, chemically bonded refers to the process of bonding using chemical bonding agents such as adhesives or bonds.

In an embodiment, instead of being directly welded or chemically bonded to a housing of the battery module 100, the coupling unit 200 is welded or chemically bonded to the clamp 250 pressing against the battery module 100. The battery cell mounted within the battery module 100 can be prevented from being damaged due to heat generated during a non-mechanical coupling process or due to other chemical reactions.

In a case where the fastening groove 330 passes through the bottom surface, the coupling unit 200 is formed in such a manner that a length in a height direction thereof is greater than a depth of the fastening groove 330. Thus, a lower end portion of the coupling unit 200 can be exposed to face below the bottom surface of the battery casing 300 in a state where the coupling unit 200 is inserted into the fastening groove 330. The coupling unit 200 is formed in such a manner that the length in the height direction thereof is greater than the depth of the fastening groove 330. A fixation force of the coupling unit 200 can be improved in many ways, such as causing the exposed lower end portion of the coupling unit 200 to extend sideways, after the coupling unit 200 passes through the fastening groove 330.

In addition, the battery module 100 is seated on the battery casing 300 through the coupling unit 200. Thus, it is no longer necessary to secure the fastening seating surface on each edge of the battery module 100 in the related art. Therefore, the securing of the fastening seating surface on each edge of the battery module 100 makes it unnecessary to cause the necessarily occurring terrace portion of the battery cell (i.e., the excess sealing material of the pouch-type battery cell) to extend sideways. Because the terrace portion of the battery cell is no longer caused to extend sideways, gas within the battery cell can be smoothly discharged. Thus, the advantage of improving the stability of the battery cell can be achieved.

The battery module 100 may be shaped in such a manner that a module bus bar output terminal 101 of the battery module 100 protrudes from only one end thereof. As illustrated in FIG. 2, the module bus bar output terminal 101, protruding from only the left end of the battery module 100, can electrically connect the inside of the battery module 100 to the outside. The module bus bar output terminal 101 is not provided on the right end of the battery module 100 or on ends other than the left end thereof.

Next, various embodiments of the present disclosure are described. However, it should be apparent that the present disclosure is not limited to these embodiments. In first to fourth embodiments described below, the fastening groove 330 is formed in a shape of a hole in a shared manner that passes through the bottom surface. The coupling unit 200 has a length in the height direction that is greater than the depth of the fastening groove 330. Thus, the lower end portion of the coupling unit 200 is exposed in the state wherein the coupling unit 200 is inserted into the fastening groove 330.

First, the first embodiment is described with reference to FIGS. 4 and 5. A first fixation portion 210 is formed on the lower end portion of the coupling unit 200 in a manner that protrudes in the vertical direction. The fastening groove 330 is formed in such a manner that a length in the vertical direction thereof is equal to or greater than a length of the vertical direction of the lower end portion of the coupling unit 200. In a state of being inserted into the fastening groove 330, the coupling unit 200 is slid in such a manner as to prevent a gap from occurring between an upper end of the coupling unit 200 and the fastening groove 330. Then, the lower end portion of the coupling unit 200 is caused to extend sideways in such a manner as to be brought into surface contact with the battery casing 300. The first fixation portion 210 serves to enhance the fixation force. In detail, with reference to FIG. 5, the first fixation portion 210 is positioned outward from the fastening groove 330 in a state where the coupling unit 200 is caused to extend sideways in such a manner as to be brought into surface contact with the battery casing 300. In a case where the battery module 100 is shaken in an upward-downward direction with an external force, the first fixation portion 210 can be hooked onto the fastening groove 330, thereby preventing the battery module 100 from being separated. In addition, in order to enhance the fixation force, the lower end portion of the coupling unit 200 is caused to extend sideways in such a manner as to be brought into surface contact with the battery casing 300. Then, a fixation material can be applied to the vicinity of a surface contact portion, thereby fixing the coupling unit 200.

Next, the second embodiment is described with reference to FIGS. 6 and 7. The first fixation portion 210 is formed on the lower end of the coupling unit 200 in such a manner as to protrude in the vertical direction. The fastening groove 330 is formed in such a manner that the length in the vertical direction thereof is equal to or greater than the length in the vertical direction of the lower end portion of the coupling unit 200. A first binding unit 220 and a second binding unit 221 are formed in such a manner as to correspond to each other, in the state where the lower end portion of the coupling unit 200 is caused to extend sideways in such a manner as to be brought into surface contact with the battery casing 300. The first binding unit 220 and the second binding unit 221 are provided in the lower end portion of the coupling unit 200 and the battery casing 300, respectively. A fastening mechanism 225 is bound into each of the first binding unit 220 and the second binding unit 221. Therefore, in a state where the coupling unit 200 is bent in such a manner as to be brought into surface contact with the battery casing 300, the first binding unit 220 and the second binding unit 221 correspond to each other. Thus, the fastening mechanism 225 can be bound into the first binding unit 220 and the second binding unit 221, thereby fixing the battery module 100.

The third embodiment is now described with reference to FIG. 8. The first fixation portion 210 is formed on the lower end of the coupling unit 200 in such a manner as to protrude in the vertical direction. The fastening groove 330 is formed in such a manner that the length in the vertical direction thereof is equal to or greater than the length in the vertical direction of the lower end portion of the coupling unit 200. A second fixation portion 211 is formed on an end portion of the first fixation portion 210 in a manner that protrudes in the height direction. A coupling groove 310, into which the second fixation portion 211 is coupled, is formed in the battery casing 300. Thus, the second fixation portion 211 is coupled into the coupling groove 310 in a state where the coupling unit 200 is inserted into the fastening groove 330. The coupling unit 200 is inserted into the fastening groove 330, and then is slid in such a manner as to prevent a gap from occurring between the upper end of the coupling unit 200 and the fastening groove 330. In this state, the first fixation portion 210 protrudes out of the fastening groove 330, thereby blocking the battery module 100 from being separated in the upward-downward direction. The second fixation portion 211, coupled into the coupling groove 310, serves to block the battery module 100 from being separated or shaken in a leftward-forward direction. Accordingly, the first fixation portion 210 and the second fixation portion 211 both serve to enhance the fixation force.

The fourth embodiment is described now with reference to FIG. 9. The coupling unit 200 is formed in such a manner that a lower end portion thereof is caused to extend in the horizontal direction. One side portion of the fastening groove 330 is formed to have a greater width in the horizontal direction than the lower end portion of the coupling unit 200 in such a manner that the lower end portion, extending sideways, of the coupling unit 200 passes through the fastening groove 330. The coupling unit 200 is inserted into the fastening groove 330 through the one side portion thereof and is slid to the other side portion having a smaller width in the horizontal direction than the one side portion. As a result, the coupling unit 200 is fixed to the fastening groove 330. The coupling unit 200 is formed in such a manner that the lower end portion thereof is caused to extend in the horizontal direction and the coupling unit 200 is inserted through the one side portion having a greater width into the fastening groove 330 and then is slid to the other side portion have a smaller width. Thus, in a case where the battery module 100 is likely to be separated in the upward-downward direction, the lower end portion of the coupling unit 200 is hooked onto the other side portion, thereby blocking the battery module 100 from being separated. A blocking portion 331 is formed on the other side portion of the fastening groove 330 in a manner that protrudes in the vertical direction. The coupling unit 200 is slid to the other side portion of the fastening groove 330. Then, the coupling unit 200 can be fastened into the fastening groove 330. The coupling unit 200 is fixed to the fastening groove 330 by the locking portion 331. Thus, the battery module 100 can be blocked from being shaken or separated in the leftward-rightward direction.

Therefore, according to embodiments the present disclosure, the battery casing 300 and the battery module 100 are coupled to each other by employing a new-type fastening technique instead of a fastening technique used in the related art. Thus, the stability and the energy density of the battery can be improved when compared with a battery assembly in the related art.

In addition, a member structure that, in the related art, is required to couple a battery casing and a battery module can be eliminated in the battery assembly according to embodiments of the present disclosure, thereby reducing the weight of the battery assembly. Furthermore, the space in the width of the battery casing 300, which would be otherwise occupied by the member, can be utilized for loading the battery module 100.

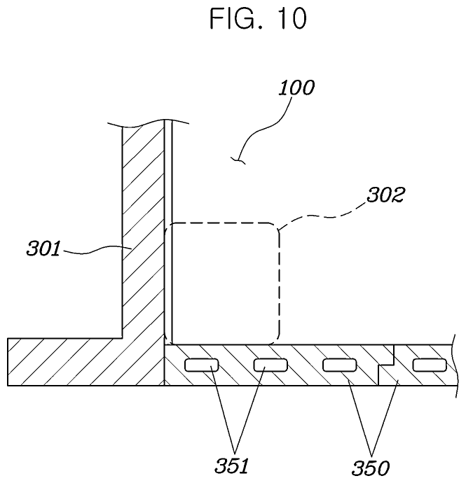

As illustrated in FIG. 10, pack side members 301, respectively provided on both sides of the battery casing 300, along with the cooling channel 350, forms a corner portion 302 within the battery casing 300. In the related art, a member for fixing the battery module 100 is required to be separately mounted to the corner portion 302. However, according to embodiments of the present disclosure, the member is eliminated. Thus, a lower edge of the battery module 100 can be directly inserted into the corner portion 302 that is formed by the pack side member 301 and the cooling channel 350. This can increase the battery loading space in the battery casing 300 and can contribute to a reduction in the weight of the battery casing 300.

The present disclosure is not limited to embodiments thereof that are described above with reference to the accompanying drawings. The scope of the present disclosure is defined by the following claims. Therefore, it should be apparent to a person of ordinary skill in the art that various modifications and alterations can be made to the embodiments of the present disclosure without departing from the scope of the technical idea of the present disclosure.

What is claimed is:

1. A battery assembly comprising:
a battery casing having a bottom surface on which a cooling channel is provided, wherein a plurality of fastening grooves is formed by recessing the bottom surface at a plurality of points thereon; and
a battery module, wherein
a lower surface of the battery module is seated on the bottom surface of the battery casing,
a plurality of coupling units is provided on an edge of the lower surface of the battery module at a plurality of points thereon, wherein the coupling units, among the plurality of coupling units, are positioned to protrude toward the bottom surface of the battery casing in such a manner as to correspond to the plurality of fastening grooves, and
when the battery module is seated on the battery casing, respective ones of the coupling units are inserted into respective ones of the fastening groove, thereby being hooked and fixed thereto and keeping the lower surface of the battery module in contact with the cooling channel on the bottom surface.

2. The battery assembly of claim 1, wherein the cooling channel is formed by being extrusion-molded in a vertical direction, and wherein a flow path, along which a cooling medium flows, is formed in a straight line along the vertical direction within the cooling channel.

3. The battery assembly of claim 1, wherein a plurality of flow paths is formed in the cooling channel, and a fastening groove, among the plurality of fastening grooves, is formed in a manner that avoids overlapping with the cooling channel.

4. The battery assembly of claim 1, wherein a plurality of flow paths is formed in the cooling channel, wherein at least some flow paths, among the plurality of flow paths, are spaced from each other, and wherein a fastening groove, among the plurality of fastening grooves, is formed at a point where the flow paths are separated from each other.

5. The battery assembly of claim 1, wherein the coupling units, among the plurality of coupling units, are welded or chemically bonded to clamps provided on both sides of the battery module, and wherein the clamps press against the battery module.

6. The battery assembly of claim 1, wherein:
an upper end portion of a coupling unit, among the plurality of coupling units, is caused to extend in a horizontal direction, thereby forming a coupling seating surface; and
the coupling unit is welded or chemically bonded to a clamp in a state where the coupling seating surface is brought into surface contact with the clamp.

7. The battery assembly of claim 1, wherein an injection hole is formed in the battery casing in a manner that passes through the bottom surface of the battery casing, and wherein a gap filler is applied through the injection hole after the battery module is seated.

8. The battery assembly of claim 1, wherein a fastening groove, among the plurality of fastening grooves, is a hole in the battery casing that passes through the bottom surface thereof.

9. The battery assembly of claim 8, wherein a coupling unit, among the plurality of coupling units, is formed in such a manner that a length in a height direction thereof is greater than a depth of the fastening groove, and wherein a lower end portion of the coupling unit is exposed to face below the bottom surface of the battery casing in a state where the coupling unit is inserted into the fastening groove.

10. The battery assembly of claim 9, wherein:
a first fixation portion is formed on the lower end portion of the coupling unit in a manner that protrudes in a vertical direction;
the fastening groove is formed in such a manner that a length in a vertical direction thereof is equal to or greater than a length of the vertical direction of the lower end portion of the coupling unit; and
in a state of being inserted into the fastening groove,
the coupling unit is slid in such a manner as to prevent a gap from occurring between an upper end of the coupling unit and the fastening groove, and
the lower end portion of the coupling unit is caused to extend sideways in such a manner as to be brought into surface contact with the battery casing.

11. The battery assembly of claim 10, wherein:
the lower end portion of the coupling unit is caused to extend sideways in such a manner as to be brought into surface contact with the battery casing; and
a fixation material is applied to a vicinity of a surface contact portion, thereby fixing the coupling unit.

12. The battery assembly of claim 10, wherein a first binding unit and a second binding unit are formed in such a manner as to correspond to each other, in a state where the lower end portion of the coupling unit is caused to extend sideways in such a manner as to be brought into surface contact with the battery casing, and wherein the first binding unit and the second binding unit are provided in the lower end portion of the coupling unit and the battery casing, respectively.

13. The battery assembly of claim 10, wherein:
a second fixation portion is formed on an end portion of the first fixation portion in a manner that protrudes in the height direction;
a coupling groove, into which the second fixation portion is coupled, is formed in the battery casing, and
the second fixation portion is coupled into the coupling groove in a state where the coupling unit is inserted into the fastening groove.

14. The battery assembly of claim 9, wherein:
the coupling unit is formed in such a manner that a lower end portion thereof is caused to extend in a horizontal direction;
one side portion of the fastening groove is formed to have a greater width in the horizontal direction than the lower end portion of the coupling unit in such a manner that the lower end portion, extending sideways, of the coupling unit passes through the fastening groove; and
the coupling unit is inserted into the fastening groove through the one side portion thereof and is slid to another side portion having a smaller width in the horizontal direction than the one side portion, thereby being fixed.

15. The battery assembly of claim 14, wherein:
a blocking portion is formed on another side portion of the fastening groove in a manner that protrudes in a vertical direction;
the coupling unit is slid to another side portion of the fastening groove; and
the coupling unit is fixed to the fastening groove by the blocking portion.

16. The battery assembly of claim 1, wherein respective pack side members are provided on both sides of the battery casing, and wherein the battery module is coupled in such a manner that a lower edge thereof is directly inserted into a corner portion that is formed by a pack side member and the cooling channel.
